(19) United States
(12) Patent Application Publication
(10) Pub. No.: US 2016/0204445 A1
(43) Pub. Date: Jul. 14, 2016

(54) CATHODE CATALYST FOR METAL-AIR BATTERY, METHOD FOR MANUFACTURING SAME, AND METAL-AIR BATTERY COMPRISING SAME

(71) Applicant: KOREA INSTITUTE OF ENERGY RESEARCH, Daejeon (KR)

(72) Inventors: Kyu-nam JUNG, Daejeon (KR); Jong-won LEE, Daejeon (KR); Kyung-hee SHIN, Daejeon (KR); Chang-soo JIN, Daejeon (KR); Bum-suk LEE, Daejeon (KR); Myung-seok JEON, Daejeon (KR); Jae-deok JEON, Daejeon (KR); Sun-hwa YEON, Daejeon (KR); Joon-mok SHIM, Daejeon (KR); Jung-hoon YANG, Daejeon (KR); Jong-hyuk JUNG, Daejeon (KR)

(21) Appl. No.: 14/889,143

(22) PCT Filed: Aug. 29, 2014
(86) PCT No.: PCT/KR2014/008063

§ 371 Date: Nov. 4, 2015

(30) Foreign Application Priority Data
Sep. 17, 2013 (KR) 10-2013-0111670

(51) Int. Cl. H01M 4/90; H01M 12/08

(52) U.S. Cl. CPC H01M 4/9033; H01M 12/08; H01M 2004/8689

(57) ABSTRACT

The present invention relates to a cathode catalyst for a metal-air battery, a method for manufacturing the same, and a metal-air battery comprising the same. More specifically, the present invention relates to a cathode catalyst for a metal-air battery, a method for manufacturing the same, and a metal-air battery comprising the same having an improved storage capacity for charging/discharging and an increased charge-discharge cycle lifetime. The cathode catalyst is characterized by having a layered perovskite structure, and including lanthanum and nickel oxides. The cathode catalyst including the layered perovskite is used for manufacturing a cathode for a metal-air battery, and a metal-air battery is provided using the same. As a result, the charge-discharge polarisation of the metal-air battery is decreased, the storage capacity is increased, and the charge-discharge cycle lifetime can be improved.

### TECHNICAL FIELD

The present invention relates to cathode catalysts for metal-air batteries, methods for manufacturing the same, and metal-air batteries including the same, and more specifically, to cathode catalysts for metal-air batteries that may accelerate oxygen reaction at the anode of the metal-air battery, methods for manufacturing the same, and metal-air batteries including the same.

### DISCUSSION OF RELATED ART

A metal-air battery means a battery that employs a metal, such as lithium (Li), zinc (Zn), aluminum (Al), magnesium (Mg), iron (Fe), calcium (Ca), or sodium (Na) as its anode and oxygen (O2) in the air as its cathode active material and is a brand-new energy storage means that may replace existing lithium ion batteries. At the anode of a metal-air battery the metal is oxidated/reduced while at the cathode air, coming in from the outside, is oxidated/reduced. Such metal-air battery is a battery system where secondary battery and fuel cell battery techniques come together. The theoretical capacities of lithium and zinc reach up to 3,870 mAh g⁻¹ and 820 mAh g⁻¹, respectively. Metal-air batteries adopting, as their cathode, oxygen that exist unlimitedly in nature benefit higher energy density over other secondary cells.

A lithium-air battery typically consists of an anode, a cathode, and an electrolyte and separator between the anode and cathode, and its structure may come in three types depending on the type of electrolyte used.

First, the non-aqueous lithium-air battery using a non-aqueous electrolyte is simple in structure and high in energy density, but have the issues that a reaction product, solid Li₂O₂, may clog up air holes of the air electrode, resulting in discharge done earlier and that the electrolyte may be dissolved. Further, it suffers from lower discharge energy efficiency due to higher voltage at the air electrode.

The aqueous lithium-air battery employing an aqueous electrolyte exhibits a higher operation voltage over the organic-based lithium-air battery and a lower excessive voltage but requires a protection film that prevents direct contact between the lithium anode and the aqueous electrolyte.

The hybrid lithium-air battery adopts a non-aqueous electrolyte on the side of the lithium anode, an aqueous electrolyte on the side of the air electrode, and a lithium ion conductive solid electrolyte film to separate the two electrolytes from each other. This type of lithium-air battery comes up with the benefits of both the non-aqueous and aqueous lithium-air batteries. The hybrid lithium-air battery may prevent direct contact between the lithium electrode and moisture and may present a higher charge/discharge energy efficiency thanks to lower excessive voltage at the air electrode.

The last type is the zinc-air battery. The zinc-air battery presents higher energy density, enabling it to apply to both mid- or large-sized power sources for automobiles and compact batteries for portable devices. Further, the oxygen at the air electrode, after reaction, is reduced to hydroxyl ions (OH⁻) which are incombustible unlike organic solvents for lithium-ion secondary cells. Thus, the zinc-air battery may present higher safety. The zinc-air battery uses zinc powder for the anode, which is abundant and costs less than 1/100 of lithium, and are thus more economical. Further, this battery may provide a steady voltage characteristic until the zinc powder is completely oxidated to ZnO and may cause less environmental load, allowing for a clean and high-capacity battery.

Typically, the hybrid lithium-air battery and the zinc-air battery contain porous carbon as an element of the cathode, but due to being less active to the oxygen reduction/oxidation reaction in the aqueous solution used as the cathode electrode, the excessive voltage upon charge-discharge is higher than the theoretical value, the batteries suffer from reduced energy efficiency. Thus, there is a need to develop a catalyst that may accelerate oxidation at the cathode of a metal-air battery using an alkali aqueous solution as its electrolyte to reduce excessive voltage while increasing energy efficiency.

### SUMMARY

The present invention has been made considering the above issues of the prior art and aims to provide a cathode catalyst for metal-air batteries that may increase charge-discharge capacity of batteries and charge-discharge cycle lifespan, a method for manufacturing the same, and a metal-air battery including the same.

The present invention addresses the above issues and provides a cathode catalyst for a metal-air battery including a lanthanum-nickel oxide having a layered perovskite structure.

The metal may be selected from the group consisting of zinc (Zn), aluminum (Al), magnesium (Mg), iron (Fe), calcium (Ca), and sodium (Na).

The molar ratio of nickel relative to lanthanum is preferably 195 through 2.05.

Part of the lanthanum may be replaced by one or more species of substitutes selected from calcium (Ca) or strontium (Sr).

The present invention also provides a method for manufacturing a cathode catalyst for a metal-air batter comprising: a first step of preparing a mixture by dissolving a lanthanum and nickel nitrate in ethylene glycol and distilled water; a second step of preparing a sol by mixing the mixture prepared in the first step with citric acid; a third step of forming a gel by heating the sol prepared in the second step; a fourth step of pyrolizing the gel formed in the third step; and a fifth step of preparing a cathode catalyst by thermal-treating a material obtained in the fourth step.

The method may further include the step of cooling and crashing the cathode catalyst.

It is preferable that 5 to 50 parts by weight of the ethylene glycol is added with respect to 100 parts by weight of the distilled water.

Preferably, the amount of citric acid added is one to five times the number of moles of the lanthanum and nickel nitrate added in the first step.

In the third step, the sol is heated preferably at 60° C. to 80° C.

In the fourth step, the gel is pyrolized preferably at 200° C. to 300° C.

In the fifth step, the temperature of the thermal treatment is preferably 500° C. to 1000° C.

The present invention also provides a catalyst for a metal-air battery including carbon, a binder, and the cathode catalyst for a metal-air battery.

The carbon may be selected from the group consisting of sorts of carbon black, sorts of graphite, sorts of graphene, sorts of active carbon, and sorts of carbon fiber.

The binder may be selected from the group consisting of vinylidene fluoride, polyacrylonitrile, polymethylmethacrylate, and polytetrafluoroethylene and styrene butadiene rubber-based polymer.

The present invention also provides a metal-air battery comprising: a cathode for a metal-air battery as set forth in claim 12; an anode selected from the group zinc (Zn), aluminum (Al), magnesium (Mg), iron (Fe), calcium (Ca), and sodium (Na); a porous separator; and an alkali electrolyte.

The alkali electrolyte may be selected from the group consisting of KOH, NaOH, and LiOH.

The separator may be selected from the group consisting of glass fiber, polyester, Teflon, polyethylene, polypropylene, and polytetrafluoroethylene (PTFE).

According to the present invention, the cathode catalyst for a metal-air battery includes lanthanum nickel oxide having a layered perovskite structure, thereby reducing charge-discharge polarization of the metal-air battery while increasing storage capacity and charge-discharge cycle lifespan.

### BRIEF DESCRIPTION OF DRAWINGS

FIG. 1 is a view illustrating X-ray diffraction patterns of cathode catalyst powders manufactured according to embodiments 1, 2, and 3.

FIG. 2 shows the RDE test result obtained by measuring the activity to oxygen reduction of the cathode catalysts produced in embodiments 1, 2, and 3 and comparison example 1.

FIG. 3 shows the RDE test result obtained by measuring the activity to oxygen oxidation (generation) of the cathode catalysts produced in embodiments 1, 2, and 3 and comparison example 1.

FIG. 4 is a view illustrating the polarization curves of the lithium-air batteries produced in embodiment 3 and comparison example 1.

FIG. 5 is a view illustrating the polarization curves of the zinc-air batteries produced in embodiment 3 and comparison examples 1 and 2.

### DESCRIPTION OF EXEMPLARY EMBODIMENTS

Hereinafter, the present invention is described in detail. Relevant known configurations or functions may be excluded from the description of the present invention.

The terms used herein should be interpreted not in typical or dictionary definitions but to comply in concept with the technical matters of the present invention.

The configurations disclosed in the specification and the drawings are mere examples and do not overall represent the technical spirit of the present invention. Therefore, various changes may be made thereto, and equivalents thereof also belong to the scope of the present invention.

According to the present invention, the cathode catalyst for a metal-air battery includes a lanthanum-nickel oxide having a layered perovskite structure.

The lanthanum-nickel oxide has an excellent catalyst activity to an oxygen reduction and oxidation reaction. Further, the layered perovskite structure has a layer of a rock-salt structure with various oxygen contents between existing perovskite structures, and such difference in structure further accelerates the oxygen reduction and oxidation reaction.

The molar ratio of lanthanum to nickel is preferably 195 through 2.05:1.

Here, leaving the lanthanum-nickel molar ratio off the upper and lower limits of the range may render it impossible to synthesize a perovskite catalyst of a layered structure, and is thus not preferred.

Part of the lanthanum is preferably replaced by one or more species of substitutes selected from calcium (Ca) or strontium (Sr) in the first and second steps above.

Adding the substitute may increase the oxygen vacancy concentration in the lanthanum-nickel oxide and form trivalent Ni ions, thereby increasing electric conductivity and oxygen exchange reaction speed on the surface.

A method for manufacturing a cathode catalyst for a metal-air battery, as described above, includes a first step of preparing a mixture by dissolving a lanthanum and nickel nitrate in ethylene glycol and distilled water; a second step of preparing a sol by mixing the mixture prepared in the first step with citric acid; a third step of forming a gel by heating the sol prepared in the second step; a fourth step of pyrolizing the gel formed in the third step; and a fifth step of preparing a cathode catalyst by thermal-treating a material obtained in the fourth step.

The method may further include the step of cooling and crashing the cathode catalyst.

It is preferable that 5 to 50 parts by weight of the ethylene glycol is added with respect to 100 parts by weight of the distilled water.

Here, the ethylene glycol is used as a solvent and chelation agent to dissolve the metal salts, and in case the amount added is smaller than the lower limit of the range, the chelation reaction of metal ions may not properly proceed, while if the amount added exceeds the upper limit of the range, the salts may not be evenly dispersed. This is not preferable.

Preferably, the amount of citric acid added is one to five times the number of moles of the lanthanum and nickel nitrate added in the first step.

Here, the citric acid is used as a chelation agent. The amount added being smaller than the lower limit of the range renders it difficult to synthesize a homogeneous and high-purity substance while the amount exceeding the upper limit of the scope may interfere with proper chelation reaction of the metal ions. This is not preferable.

The first step and the second step may be performed sequentially or simultaneously.

In the third step, the sol may be heated preferably at 60° C. to 80° C. The heating temperature being less than 60° C. may be too low to form the gel, and the heating temperature being more than 80° C. may form the gel too early, rendering it difficult for the gel to have a homogeneous composition. This is not preferable.

In the fourth step, the sol may be pyrolized preferably at 200° C. to 300° C. The pyrolysis temperature being less than 200° C. may be too low to pyrolize the gel, and the pyrolysis temperature being more than 300° C. may cause crystallization simultaneously with the pyrolysis, rendering it difficult for the obtained oxide to have a homogeneous composition. This is not preferable.

In the fifth step, the thermal-treatment temperature may be preferably 500° C. to 1000° C. The thermal-treatment temperature being less than 500° C. may prevent crystallization from arising, and the thermal-treatment temperature being more than 1000° C. may render the obtained oxide to have coarse particles. This is not preferable.

By the cathode catalyst for a metal-air battery, a cathode for a metal-air battery may be prepared by forming a cathode composition including a binder and carbon, forming the cathode composition in a predetermined shape or coating the same on a collector such as a nickel mesh.

Here, a separate conductor and solvent may be added to the cathode composition to prepare the cathode for a metal-air battery.

The method for manufacturing the cathode is described in greater detail. A cathode plate may be obtained by directly coating the cathode composition on the nickel mesh collector or by casting the cathode composition onto a separate support and laminating a cathode film peeled off from the support on the nickel mesh collector. The cathode for a metal-air battery may have other forms without limited to those enumerated above.

The binder as used may be selected from the group consisting of vinylidene fluoride, polyacrylonitrile, polymethylmethacrylate, and polytetrafluoroethylene and styrene butadiene rubber-based polymer, and the carbon as used may be selected from the group consisting of sorts of carbon black, sorts of graphite, sorts of graphene, sorts of active carbon, and sorts of carbon fiber.

The content of the binder and the carbon may be properly adjusted within a range typically used upon manufacture of electrodes for zinc batteries.

The metal-air battery employing the cathode for a metal-air battery includes a cathode for a metal-air battery, an anode selected from the group consisting of zinc (Zn), aluminum (Al), magnesium (Mg), iron (Fe), calcium (Ca), and sodium (Na); a porous separator; and an alkali electrolyte.

A method for manufacturing a metal-air battery is briefly described below.

First, a cathode including the cathode catalyst for a metal-air battery is prepared. Next, an anode is prepared using an active material, such as zinc (Zn), aluminum (Al), magnesium (Mg), iron (Fe), calcium (Ca), or sodium (Na) or an alloy thereof, which is typically used in the art to which the present invention pertains. Then, a porous separator having an alkali electrolyte impregnated is placed between the cathode plate and the anode plate, forming a battery structure.

Any separator that is typically used in a metal battery may be used as the separator. In particular, it is preferable to use a separator having a low resistance to the movement of ions of the electrolytes and capable of better impregnation. For example, the separator may be a piece of non-woven fabric or woven fabric as selected from glass fiber, polyester, Teflon, polyethylene, polypropylene, polytetrafluoroethylene (PTFE) or a combination thereof. Specifically, polyethylene or polypropylene may be put to use.

The alkali electrolyte as used may be selected from the group consisting of KOH, NaOH, and LiOH.

According to the present invention, the use of the alkali electrolyte may present increased activity to an oxygen reaction when nickel with a higher oxidation number is used. For example, in case La is replaced with Sr and Ca, the concentration of Ni³⁺ which is high in Ni oxidation number increases, and as the content of Ni³⁺ with a higher Ni oxidation number increases, the oxygen activity of the catalyst may increase.

The metal-air battery is appropriate for high-capacity purposes such as use in electric vehicles and may also be used in hybrid vehicles by combining with existing internal-combustion engines, fuel cells, or super capacitors. Further, the metal-air battery may also be used for all other purposes requiring high capacity such as mobile phones or portable computers.

The present invention is now described in further detail in connection with embodiments thereof. The embodiments are provided merely to specifically describe the present invention, and it is obvious to one of ordinary skill in the art that the scope of the present invention is not limited to the embodiments.

### Embodiment 1

### 1) Preparation of Cathode Catalyst

Lanthanum nitrate, calcium nitrate, and nickel nitrate were chosen as starting materials. The starting materials were measured and prepared in the molar ratio of 1.9:0.1:1 for La:Ca:Ni. Then, the starting materials were dissolved in ethylene glycol and distilled water and citric acid was then added, thereby forming a sol. Here, 10 parts by weight of the ethylene glycol were added with respect to 100 parts by weight of the distilled water, and the amount of citric acid added was three times the total number of moles of all the starting materials. The solution was heated at 70° C. to form the gel. The gel was kept heated and was pyrolized at 250° C. Subsequently, thermal treatment was performed at 900° C. for five hours, thereby forming a catalyst. The catalyst was cooled and crashed in the furnace.

### 2) Preparation of Cathode

The formed cathode catalyst, carbon black (Ketjen Black), conductor carbon (Super-P), and PTFE binder were mixed in the weight ratio of 20:60:10:10, and a paste was prepared using ethanol. The paste was laminated into a film that was then dried at 60° C. for 24 hours. The film was laminated on both surfaces of a nickel mesh, thereby forming a cathode plate.

### 3) Manufacture of Hybrid Lithium-Air Battery

A lithium anode, an electrolyte where 1M LiPF₆ is dissolved in a mixed solution of ethylene carbonate and dimethyl carbonate (50:50 Vol. %), a separator, and an LTAP solid electrolyte film were layered and were then sealed so that part of the LATP solid electrolyte film is exposed. A mixed electrolyte of 1M LiNO₃ and 0.5M LiOH was dropped on the anode, and a cathode plate was deposited, forming a hybrid lithium-air battery.

### 4) Manufacture of Zinc-Air Battery

For a zinc anode, a zinc (Zn) powder, a 6M KOH aqueous solution, and a polyacrylic acid gelling agent were mixed and kneaded in a weight ratio of 75:24.5:0.5 and were put in a SUS container. A separator where a 6M KOH alkali aqueous solution is in precipitation was deposited on the anode, and a cathode plate was deposited on the separator, forming a zinc-air battery.

### Embodiment 2

A cathode catalyst, a cathode plate, and a metal-air battery were prepared in the same method as in embodiment 1 except that the molar ratio of La, Sr, and Ni is 1.9:0.1:1.

### Embodiment 3

A cathode catalyst, a cathode plate, and a metal-air battery were prepared in the same method as in embodiment 1 except that the molar ratio of La, Sr, and Ni is 1.7:0.3:1.

### Comparison Example 1

A cathode plate and a metal-air battery were prepared in the same method as in embodiment 1 except that a paste was prepared by mixing carbon black (Ketjen Black), conductor carbon (Super-P), and PTFE binder in a weight ratio of 80:10:10 without using a cathode catalyst and a cathode plate was then prepared.

### Comparison Example 2

A cathode plate and a lithium-air battery were prepared in the same method as in embodiment 1 except that a paste was prepared by mixing a mixture of 40 wt % platinum (Pt) and 6 wt % activated carbon, carbon black (Ketjen Black), conductor carbon (Super-P), and PTFE binder in a weight ratio of 20:60:10:10 and a cathode plate was then prepared.

### Assessment Example 1

### X-Ray Diffraction Test

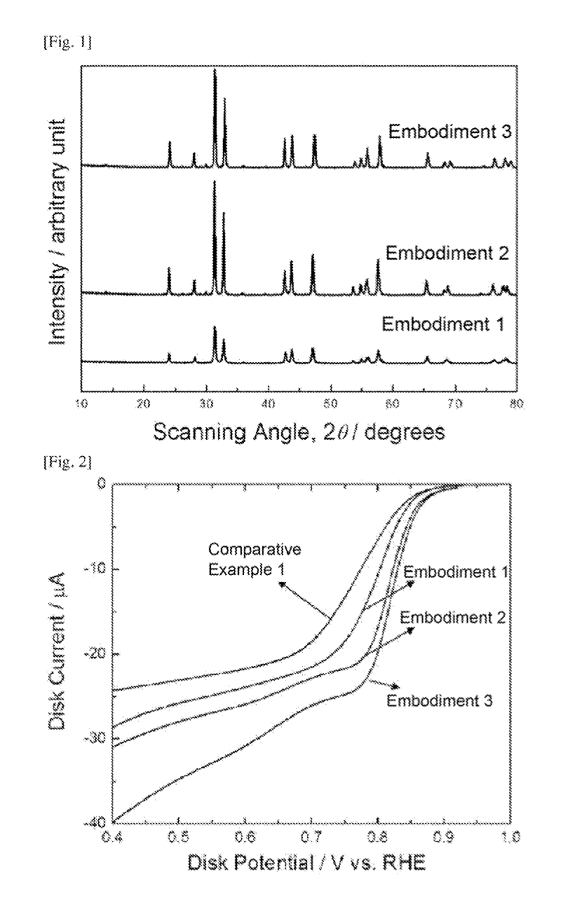

An X-ray diffraction test was conducted to grasp the crystal structure of the cathode catalysts manufactured in embodiments 1, 2, and 3. A result of the test is shown in FIG. 1. As evident from FIG. 1, the cathode catalyst powders produced in embodiments 1, 2, and 3 each has a layered perovskite structure, leaving no secondary phase or imparity phase.

### Assessment Example 2

### Rotating Disk Electrode (RDE) Test

A rotating disk electrode (RDE) test was conducted to assess the activity of the cathode catalysts produced in embodiments 1, 2, and 3 and comparison example 1. Each cathode catalyst and carbon black (Ketjen Black) were mixed in a weight ratio of 50:50 and were then scattered in distilled water, producing slurry for RDE electrodes. The slurry formed thus was dropped on a glassy carbon film used as a base of the RDE, and a nafion solution (5 wt %) was then dropped thereon and dried, forming an RDE electrode. This was used as an operation electrode while a platinum wire and an Hg/HgO electrode, respectively, were used as a relative electrode and a reference electrode so as to assess the capability of the catalyst.

The oxygen reduction activity was assessed by dissolving oxygen in an electrolyte and applying a potential from an open circuit voltage (OCV) in a negative direction while recording the resultant current (scan rate: 10 mV/s, RPM of the electrode: 1200 rpm). FIG. 2 shows the RDE test result obtained by measuring the activity to oxygen reduction of the cathode catalysts produced in embodiments 1, 2, and 3 and comparison example 1. As evident from embodiments 1, 2, and 3, addition of a layered perovskite structure of metal oxide catalyst may lead to increased activity as compared with comparison 1 where no catalyst is in use.

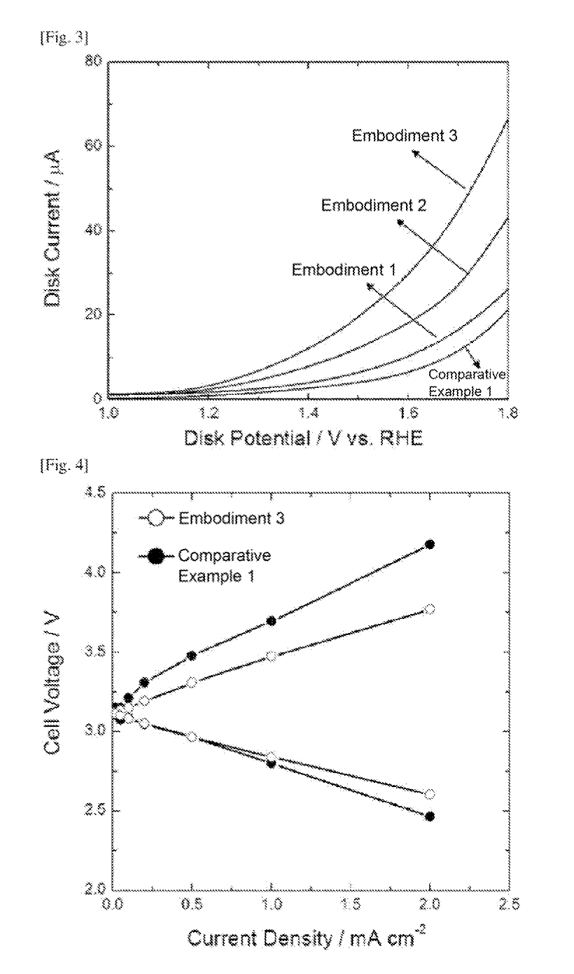

The oxygen oxidation (generation) activity was assessed by applying a potential from an open circuit voltage in a positive direction while recording the resultant current (scan rate: 10 mV/s, RPM of the electrode: 1200 rpm). FIG. 3 shows the RDE test result obtained by measuring the activity to oxygen generation of the cathode catalysts produced in embodiments 1, 2, and 3 and comparison example 1. As evident from embodiments 1, 2, and 3, addition of a layered perovskite structure of metal oxide catalyst may lead to increased activity as compared with comparison 1 where no catalyst is in use.

### Assessment Example 3

### Lithium-Air Battery Polarization Test

A polarization test was conducted using the lithium-air batteries produced in embodiment 3 and comparison example 1. Specifically, a constant current in a range from 0.01 mA cm⁻² to 2 mA cm⁻² was repeatedly applied for 30 minutes while measuring the battery's cell voltage upon discharge and recharge.

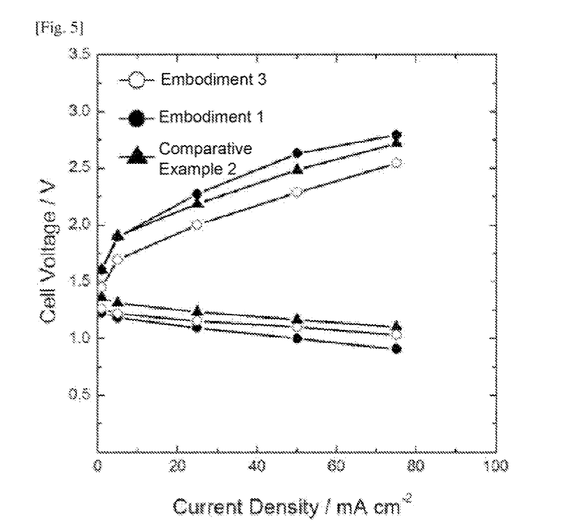

FIG. 4 shows the polarization curves of the lithium-air batteries produced in embodiment 3 and comparison example 1. As evident from embodiment 3, the lithium-air battery containing a 0.3 wt % Sr-added La_{1.7}Sr_{0.3}NiO₄ cathode catalyst exhibits reduced cell polarization upon discharge and recharge as compared with that of comparison example 1 where no catalyst is in use.

### Assessment Example 4

### Zinc-Air Battery Polarization Test

A polarization test was conducted using the zinc-air batteries produced in embodiment 3 and comparison examples 1 and 2. Specifically, a constant current in a range from 1 mA cm² to 75 mA cm⁻² was repeatedly applied for five minutes while measuring the battery's cell voltage upon discharge and recharge.

FIG. 5 shows the polarization curves of the zinc-air batteries produced in embodiment 3 and comparison examples 1 and 2. As evident from embodiment 3, the zinc-air battery containing a 0.3 wt % Sr-added La_{1.7}Sr_{0.3}NiO₄ cathode catalyst exhibits reduced cell polarization upon charge as compared with that of comparison example 1 where no catalyst is in use and that of comparison example 2 where 40 wt % Pt/C is added as catalyst.

Although preferred embodiments of the present invention have been shown and described in connection with the drawings and particular terms have been used, this is to provide a better understanding of the present invention and is not intended to limit the scope of the present invention.

It is apparent to one of ordinary skill in the art that various changes may be made thereto without departing from the scope of the present invention.

1. A cathode catalyst for a metal-air battery, comprising a lanthanum-nickel oxide having a layered perovskite structure.

2. The cathode catalyst of claim 1, wherein the metal is selected from the group consisting of zinc (Zn), aluminum (Al), magnesium (Mg), iron (Fe), calcium (Ca), and sodium (Na).

3. The cathode catalyst of claim 1, wherein a molar ratio of the lanthanum to the nickel is 1.95 through 2.05:1.

4. The cathode catalyst of claim 1, wherein part of the lanthanum is replaced with a substitute of one or more species selected from calcium (Ca) or strontium (Sr).

5. A method for manufacturing a cathode catalyst for a metal-air batter, the method comprising:
a first step of preparing a mixture by dissolving a lanthanum and nickel nitrate in ethylene glycol and distilled water;
a second step of preparing a sol by mixing the mixture prepared in the first step with citric acid;
a third step of forming a gel by heating the sol prepared in the second step;
a fourth step of pyrolizing the gel formed in the third step; and
a fifth step of preparing a cathode catalyst by thermal-treating a material obtained in the fourth step.

6. The method of claim 5, further comprising cooling and crashing the cathode catalyst.

7. The method of claim 5, wherein the ethylene glycol of 5 to 50 parts by weight is added with respect to 100 parts by weight of the distilled water.

8. The method of claim 5, wherein the citric acid added is one to five times the number of moles of the lanthanum and nickel nitrate added in the first step.

9. The method of claim 5, wherein in the third step, the sol is heated at 60° C. to 80° C.

10. The method of claim 5, wherein in the fourth step, the gel is pyrolized at 200° C. to 300° C.

11. The method of claim 5, wherein the temperature of the thermal treatment in the fourth step is 500° C. to 1000° C.

12. A cathode for a metal-air battery comprising carbon, a binder, and a cathode catalyst for a metal-air battery as set forth in claim 1.

13. The cathode of claim 12, wherein the carbon is selected from the group consisting of sorts of carbon black, sorts of graphite, sorts of graphene, sorts of active carbon, and sorts of carbon fiber.

14. The cathode of claim 12, wherein the binder is selected from the group consisting of vinylidene fluoride, polyacrylonitrile, polymethylmethacrylate, and polytetrafluoroethylene and styrene butadiene rubber-based polymer.

15. The cathode of claim 12, wherein the metal-air battery includes an anode selected from the group zinc (Zn), aluminum (Al), magnesium (Mg), iron (Fe), calcium (Ca), and sodium (Na); a porous separator; and an alkali electrolyte.

16. The cathode of claim 15, wherein the alkali electrolyte is selected from the group consisting of KOH, NaOH, and LiOH.

17. The cathode of claim 15, wherein the separator is selected from the group consisting of glass fiber, polyester, Teflon, polyethylene, polypropylene, and polytetrafluoroethylene (PTFE).
